(19) United States
(12) Patent Application Publication
(10) Pub. No.: US 2022/0346922 A1
(43) Pub. Date: Nov. 3, 2022

(54) PERIODONTAL INSTRUMENT AND METHODS OF USE

(71) Applicant: Visual Dental Solutions LLC, Eden Prairie, MN (US)

(72) Inventors: Debra Arver, Eden Prairie, MN (US); Jean Frahm, St. Paul, MN (US)

(21) Appl. No.: 17/863,244

(22) Filed: Jul. 12, 2022

Related U.S. Application Data
(63) Continuation-in-part of application No. 29/672,704, filed on Dec. 7, 2018, now Pat. No. D958362.

(51) Int. Cl. A61C 17/00

(52) U.S. Cl. CPC A61C 17/005

(57) ABSTRACT

In some embodiments, a periodontal instrument comprises an end including a functional shank and a working end located distal to the functional shank, and a handle configured to extend proximally from the end, the handle sized and configured to be received by a user's hand. The functional shank may include a colored portion, and the colored portion may define a terminal shank of the functional shank. In some embodiments, the colored portion is configured to aid the user in identifying the terminal shank.

### CROSS-REFERENCE TO RELATED APPLICATIONS

The entire contents of the following application are incorporated by reference herein: U.S. patent application Ser. No. 29/672,704; filed Dec. 7, 2018; issued as U.S. D958,362 on Jul. 19, 2022; and entitled PERIODONTAL INSTRUMENT WITH A COLORED LOWER SHANK.

### BACKGROUND

### Field

Various embodiments disclosed herein relate to periodontal instruments and methods of use. Certain embodiments discloses herein include periodontal instruments with colored terminal/lower shanks.

### Description of Related Art

Dental Hygiene is a profession that is over 100 years old. Although a dental hygienist is trained in many aspects of oral health, their core function remains overseeing patients' periodontal health through proper instrumentation during a typical dental visit by removing deposits (i.e., “cleaning” patients' teeth) that may lead to periodontal disease.

According to the CDC, nearly half the adult population 30 years of age and older, and 70% of adults age 65 and older, have periodontal disease, the most common oral disease in adults. Nonsurgical periodontal therapy used to treat this disease involves the mechanical removal of the hard and soft deposits using either ultrasonic or hand instruments. This treatment requires considerable time and a high level of operator skill. The use of appropriate instruments, and the correct use of those instruments, significantly increases clinical efficiency and outcomes.

Instrumentation is a fine motor skill that is a requisite for students, yet very challenging and difficult to master. Understanding the key concepts of instrument design, classification, grasp, fulcrum, and the three A's (adaptation, angulation, and activation) along with proper sharpening techniques are all essential in creating a solid foundation in instrumentation.

Each dental hygiene instrument has unique design characteristics enabling its usage for anterior or posterior teeth. All designs require the terminal shank to be appropriately aligned with the (crown or root) long axis of the tooth, allowing the cutting edge to create an ideal 70-80 degree angle. This angle enables the blade of the instrument to properly adapt to the tooth, rendering deposit removal successful. Holding the instrument at a particular angle is also essential when sharpening dental hygiene instruments. Instruments that are used incorrectly, or dull instruments, can lead to tissue damage and painful outcomes for the patient. Correct usage and proper sharpening of instruments are paramount.

For faculty and students of dental and dental hygiene programs, teaching and learning the use of dental hygiene instruments continues to be an extremely subjective and inconsistent obstacle to evaluation. Further, dental hygiene instruments are susceptible to improper sharpening, which can result in dull and/or damaged instruments.

There remains a need for a standardized method or instrument which removes the subjectivity of evaluating students when learning instrumentation. Without proper knowledge or attention being placed on the terminal shank to produce the ideal instrument angulation, subjectivity remains an obstacle to evaluation. In addition, there remains a need for a standardized way to visualize the angle of the instrument for proper sharpening.

### SUMMARY

The disclosure includes a periodontal instrument comprising an end including a functional shank and a working end located distal to the functional shank, wherein the functional shank includes a colored portion. The periodontal instrument may also comprise a handle configured to extend proximally from the end, the handle sized and configured to be received by a user's hand. In some embodiments, the end comprises a first end, the functional shank comprises a first functional shank, the working end comprises a first working end, and the colored portion comprises a first colored portion. The first colored portion may define a first terminal shank of the first functional shank, and the first colored portion may be configured to aid the user in identifying the first terminal shank.

In some embodiments, the periodontal instrument further comprises a second end located opposite the first end, the second end including a second functional shank and a second working end located distal to the second functional shank, wherein the second functional shank includes a second colored portion. The second colored portion may define a second terminal shank of the second functional shank, and the second colored portion may be configured to aid the user in identifying the second terminal shank. In some embodiments, the first colored portion defines a different color than the second colored portion. The first colored portion may define a same color as the second colored portion. In some embodiments, the first colored portion and the second colored portion are black.

The first colored portion may comprise a first etching on the first functional shank, and the second colored portion may comprise a second etching on the second functional shank. In some embodiments, the first colored portion comprises a first coating on the first functional shank, and the second colored portion comprises a second coating on the second functional shank.

The periodontal instrument may comprise one of an explorer, a scaler, and a curette. In some embodiments, the first working end comprises a first end including a pointed end or a rounded end, and the second working end comprises a second end including a pointed end or a rounded end. In some embodiments, the first working end comprises a first end selected from the group consisting of zero cutting surfaces, one cutting surface, and two cutting surfaces. The second working end may comprise a second end selected from the group consisting of zero cutting surfaces, one cutting surface, and two cutting surfaces.

The disclosure includes a method of using a periodontal instrument, the method comprising positioning a functional shank of the periodontal instrument adjacent a treatment site, aligning a colored portion of the functional shank with a long axis of a tooth, wherein the colored portion defines a terminal shank of the functional shank, and contacting a working end of the periodontal instrument to the tooth. In some embodiments, the functional shank comprises a first functional shank, the treatment site comprises a first treatment site, the colored portion comprises a first colored portion, the terminal shank comprises a first terminal shank, and the working end comprises a first working end. The method may further comprise positioning a second functional shank of the periodontal instrument adjacent a second treatment site, wherein the second functional shank is located opposite the first functional shank, aligning a second colored portion of the second functional shank with a long axis of a different tooth, wherein the second colored portion defines a second terminal shank of the second functional shank, and contacting a second working end of the periodontal instrument to the different tooth.

In some embodiments, the first colored portion is configured to aid a user of the periodontal instrument in identifying the first terminal shank, and the second colored portion is configured to aid the user in identifying the second terminal shank.

When the first working end of the periodontal instrument is in use, the first colored portion may be configured to be aligned substantially parallel to the long axis of the tooth. In some embodiments, when the first working end of the periodontal instrument is in use, the first colored portion is configured to be aligned at an angle to the long axis of the tooth. When the second working end of the periodontal instrument is in use, the second colored portion may be configured to be aligned substantially parallel to the long axis of the different tooth. In some embodiments, when the second working end of the periodontal instrument is in use, the second colored portion is configured to be aligned at an angle to the long axis of the different tooth.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a perspective view of a single-ended periodontal instrument, according to some embodiments.

FIG. 2 illustrates a perspective view of a double-ended periodontal instrument, according to some embodiments.

FIGS. 3A and 3B illustrate a functional shank of a periodontal instrument, according to some embodiments.

FIGS. 4 and 5 illustrate a periodontal instrument being used correctly, according to some embodiments.

FIG. 6 illustrates a periodontal instrument being used incorrectly, according to some embodiments.

FIG. 7 illustrates a perspective view of a single-ended periodontal instrument, according to some embodiments.

FIG. 8 illustrates a perspective view of a double-ended periodontal instrument, according to some embodiments.

FIGS. 9A, 9B, 10A, 10B, 11A, 11B, 12A, and 12B illustrate different embodiments of functional shanks, according to some embodiments.

FIG. 13 illustrates a periodontal instrument being sharpened, according to some embodiments.

FIG. 14 illustrates a flow chart describing the use of a periodontal instrument, according to some embodiments.

### DETAILED DESCRIPTION

Although certain embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any system or device disclosed herein, the acts or operations of the system or device may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order-dependent. Additionally, the structures, methods, and/or procedures described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### COMPONENT INDEX

100—periodontal instrument
102—end
104—functional shank
106—working end
108—colored portion
110—handle
200—periodontal instrument
202a—first end
202b—second end
204a—first functional shank
204b—second functional shank
206a—first working end
206b—second working end
208a—first colored portion
208b—second colored portion
210—handle
300a—functional shank
300b—functional shank
302a—colored portion
302b—colored portion
304a—terminal shank
304b—terminal shank
400—functional shank
402—terminal shank
404—working end
406—tooth
500—functional shank
502—terminal shank
504—working end
506—tooth
600—functional shank
602—terminal shank
604—working end
606—tooth
700—periodontal instrument
702—end
704—functional shank
706—working end
708—colored portion
710—handle
800—periodontal instrument
802a—first end
802b—second end
804a—first functional shank
804b—second functional shank
806a—first working end
806b—second working end
808a—first colored portion
808b—second colored portion
810—handle
900a—functional shank
900b—functional shank
902a—colored portion
902b—colored portion
904a—terminal shank
904b—terminal shank
1000a—functional shank
1000b—functional shank
1002a—colored portion
1002b—colored portion
1004a—terminal shank
1004b—terminal shank
1100a—functional shank
1100b—functional shank
1102a—colored portion
1102b—colored portion
1104a—terminal shank
1104b—terminal shank
1200a—handle
1200b—handle
1202a—functional shank
1202b—functional shank
1204a—colored portion
1204b—colored portion
1206a—terminal shank
1206b—terminal shank
1300—periodontal instrument
1302—functional shank
1304—colored portion
1306—terminal shank
1308—sharpening device
1310—working end

### INTRODUCTION

Each dental hygiene instrument has unique design characteristics enabling its usage for anterior or posterior teeth. All designs require the terminal shank to be aligned properly with the (crown or root) long axis of the tooth allowing the cutting edge to create an ideal 70-80 degree angle. This angle enables the blade of the instrument to properly adapt to the tooth rendering deposit removal successful. Holding the instrument at a particular angle is also important when sharpening dental hygiene instruments. Instruments that are used incorrectly, or dull instruments, can lead to tissue damage and painful outcomes for the patient. Correct usage and proper sharpening of instruments are paramount.

Disclosed herein are embodiments of dental hygiene instruments with a colored terminal shank. Coloring the terminal shank provides enhanced visualization of the terminal shank and allows users to correctly angle the instrument during use on teeth and/or when sharpening an instrument, thereby removing the guesswork of determining proper angulation. Coloring the terminal shank can benefit students, such as dental and/or dental hygiene students, by allowing them to practice instrumentation and confidently maintain proper angulation without requiring confirmation from an instructor. Further, the visual clarity provided by a color-coded terminal shank can be immensely helpful for visual learners. In addition, coloring the terminal shank can benefit dental professionals by providing a standardized look to instruments. For example, rather than having to “start over” and identify the terminal shanks on a new set of instruments and/or in a new setting (e.g., at a new job in a different dental practice), the color-coded terminal shanks may serve as a quick “refresher” and enable a more seamless return to performing periodontal care.

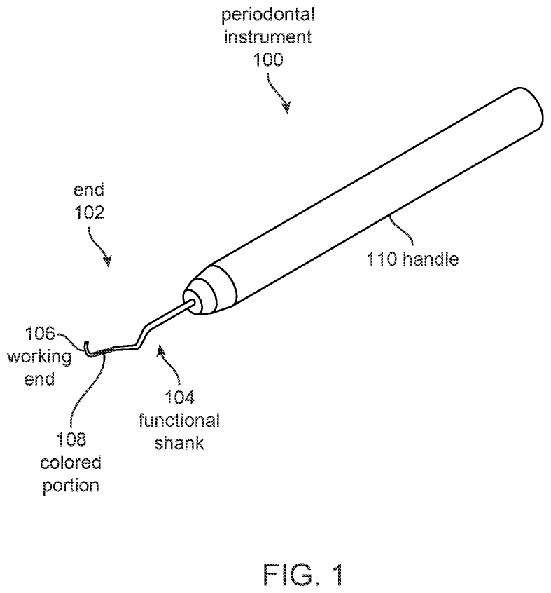

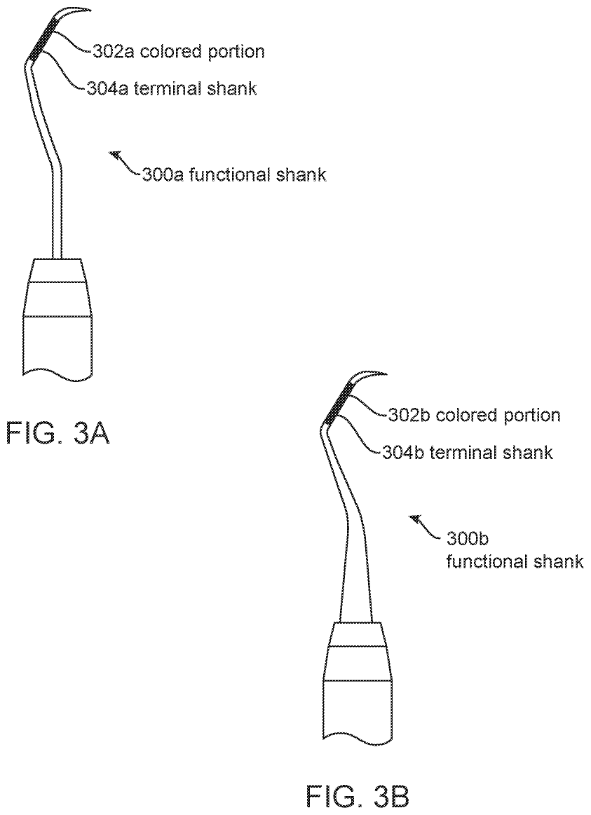

FIG. 1 illustrates a periodontal instrument 100, including an end 102 and a handle 110. As shown, the end 102 may comprise a functional shank 104, a working end 106, and a colored portion 108. In some embodiments, the working end 106 is located distal to the functional shank 104, and the handle 110 is located proximal to the functional shank 104. In some embodiments, the functional shank 104 includes the colored portion 108, such that the colored portion 108 is considered part of the functional shank 104. As will be discussed later in this disclosure, in particular with reference to FIGS. 3A and 3B, the colored portion 108 may be used to identify a specific part of the functional shank 104. The handle 110 may be sized and configured to be received by a user's (e.g., dental hygienist, dentist, dental student, etc.) hand.

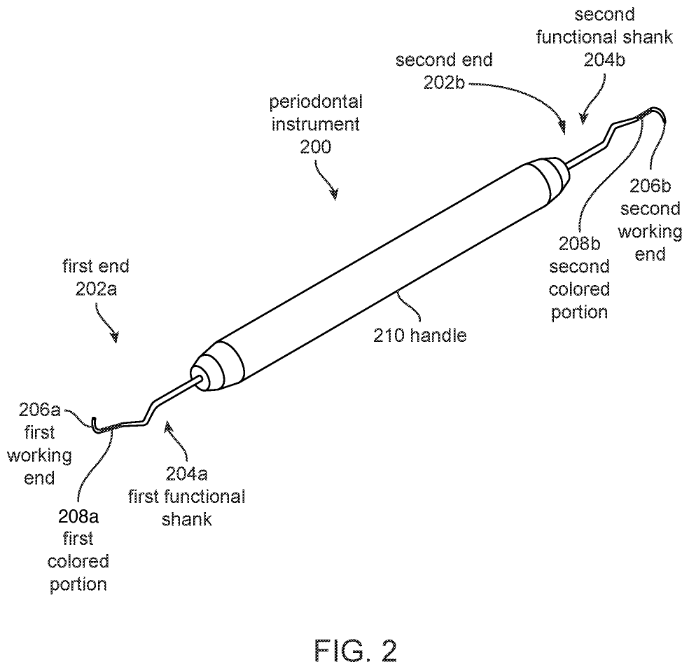

FIG. 1 illustrates a single-ended periodontal instrument 100. In some embodiments, as demonstrated in FIG. 2, a periodontal instrument 200 includes two ends—a first end 202a and a second end 202b. Similar to the end 102 shown in FIG. 1, the first end 202a may include a first functional shank 204a, a first working end 206a, and a first colored portion 208a. Likewise, the second end 202b may include a second functional shank 204b, a second working end 206b, and a second colored portion 208b. Like the functional shank 104 and colored portion 108 shown in FIG. 1, in some embodiments, the first colored portion 208a is part of the first functional shank 204a, and the second colored portion 208b is part of the second functional shank 204b. The periodontal instrument 200 may also include a handle 210, as shown in FIG. 2.

The first working end 206a and the second working end 206b may be different from one another and may be referred to as “unpaired working ends.” In some embodiments, the first working end 206a and the second working end 206b are the same and may be referred to as “paired working ends.” The first working end 206a and the second working end 206b may be mirror images of one another, such that the first working end 206a is identical to the second working end 206b, but with the structure reversed. In some embodiments, by virtue of being mirror images, the first working end 206a is arranged and configured for use on one side of the mouth, and the second working end 206b is arranged and configured for use on the other side of the mouth.

The first working end 206a and the second working end 206b may include a pointed end or a rounded end. The first working end 206a may include a cutting surface. The first working end 206a may include two cutting surfaces. In some embodiments, the first working end 206a includes no cutting surfaces. Similarly, the second working end 206b may include a cutting surface. The second working end 206b may include two cutting surfaces. In some embodiments, the second working end 206b includes no cutting surfaces. Depending on the number of cutting surfaces and whether it has a rounded end or a pointed end, the periodontal instrument 200 may comprise one of an explorer, a scaler, and a curette, as those terms are understood by persons having ordinary skill in the art of making and/or using periodontal instruments. The first working end 206a may be different from the second working end 206b such that the first working end 206a comprises, for example, a pointed end with two cutting surfaces, and the second working end 206b comprises, for example, a rounded end with no cutting surfaces. Accordingly, the periodontal instrument 200 may comprise one end that is a scaler and one end that is an explorer. It should be noted that like the periodontal instrument 200, the periodontal instrument 100 of FIG. 1 may also comprise an explorer, a scaler, or a curette. The working end 106 may also include a rounded end or a pointed end, and may include zero, one, or two cutting surfaces.

In some embodiments, an explorer is a periodontal assessment instrument for locating calculus deposits on the crowns and roots of teeth. An explorer commonly has a curved or hooked working end that is generally circular in cross-section and has a thin flexible shank. A scaler is a periodontal instrument for removing calculus deposits from the crowns of teeth and has a curved or hooked working end that is generally triangular in cross-section and has a shank that is more rigid than the shank of an explorer. A curette is a periodontal instrument used for removing calculus deposits from the crowns and roots of teeth and has a curved or hooked working end that is generally semi-circular in cross-section and has a shank that is more rigid than the shank of an explorer.

FIGS. 3A and 3B illustrate a functional shank 300a and a functional shank 300b, respectively. The functional shank 300a may differ from the functional shank 300b by having a narrower base portion adjacent the handle, as shown in FIGS. 3A and 3B, but the colored portion 302a may be the same as the colored portion 302b. In some embodiments, the colored portion 302a defines a terminal shank 304a of the functional shank 300a. Similarly, the colored portion 302b may define a terminal shank 304b of the functional shank 300b. Coloring the terminal shanks 304a, 304b with the colored portions 302a, 302b may be configured to aid a user in identifying the terminal shanks 304a, 304b. It should be noted that the portion of the functional shank referred to as the “terminal shank” throughout this disclosure may also be referred to as the “lower shank.” Within the field of dentistry, the terms “terminal shank” and “lower shank” are used interchangeably. In some embodiments, the terminal/lower shank refers to the portion of the functional shank that terminates just before the working end—usually the last bend of the functional shank. It should be noted that only the terminal shank may be colored. In some embodiments, the entirety of the terminal shank is colored, while the rest of the functional shank remains the color of its material (i.e., silver for metallic instruments).

As previously discussed in this disclosure, proper angulation of a terminal shank with respect to a long axis of a tooth is of the utmost importance when using a periodontal instrument. In some cases, especially with complicated functional shanks with multiple curves or bends, it can be difficult to identify the terminal shank, leading to user error of the periodontal instrument. User error can result in sub-par teeth cleaning (i.e., incomplete removal of deposit from a tooth's surface), injury to a patient, and/or damage to the instrument. It is therefore vital to ensure that terminal shanks can be correctly identified so that users can maintain a proper angle of the terminal shank with respect to the tooth. Further, easy identification of the terminal shank can help users more quickly switch between different periodontal instruments (i.e., instruments with different types of functional shanks) while treating a patient.

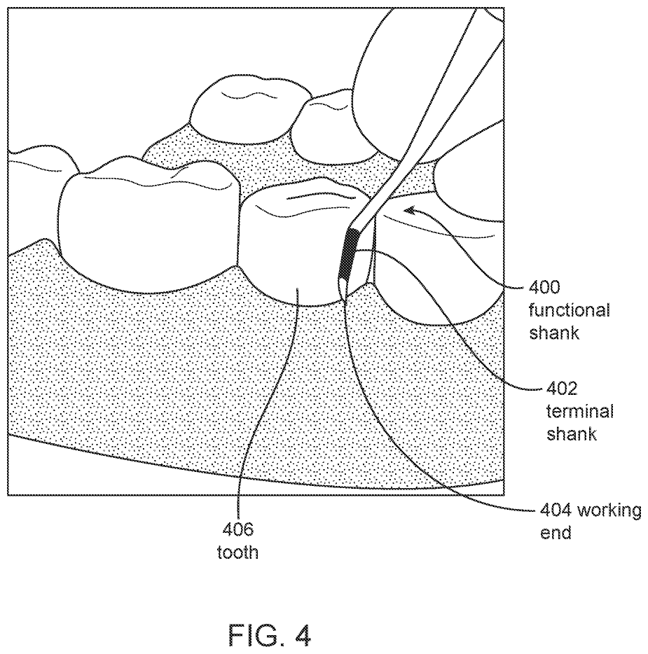

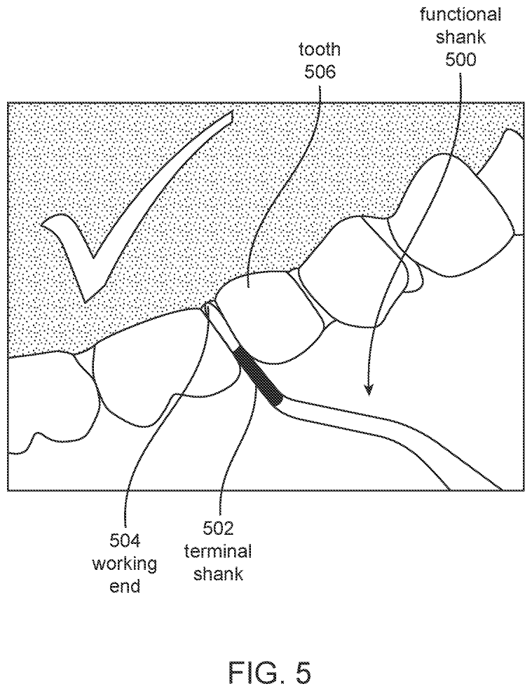

FIGS. 4 and 5 illustrate examples of proper use of a periodontal instrument. In FIG. 4, the terminal shank 402 of the functional shank 400 is shown being held substantially parallel to a long axis of a tooth 406. It should be noted that the “long axis” refers to the height of the tooth, from a top surface down to the root below the gumline, rather than the width of the tooth. Maintaining the terminal shank 402 in that position may encourage the working end 404 to contact the tooth 406 at an effective angle for treatment (e.g., deposit/plaque removal). It should be noted that though FIG. 4 shows only one tooth identified as “tooth 406,” the term “tooth 406” may refer to any one or multiple of the teeth shown in FIG. 4. Similar to FIG. 4, FIG. 5 shows the terminal shank 502 of the functional shank 500 being held substantially parallel to the long axis of the tooth 506. In FIG. 5, the working end 504 is located between two teeth.

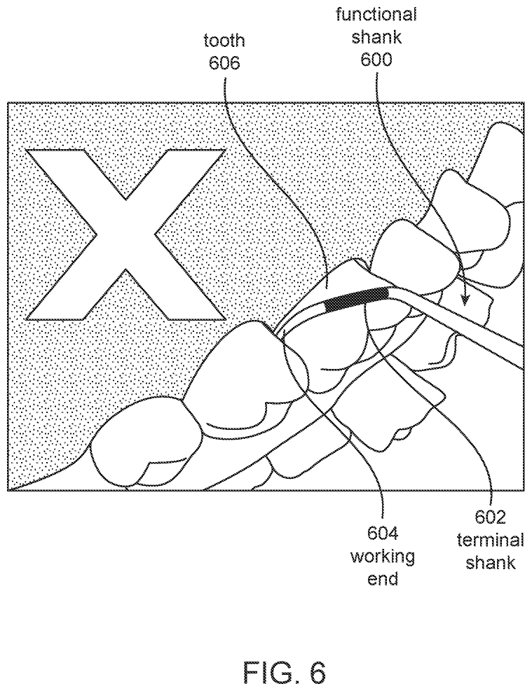

In contrast to FIGS. 4 and 5, FIG. 6 illustrates incorrect use of a periodontal instrument. As demonstrated, the terminal shank 602 of the functional shank 600 is held at an extreme angle to the tooth 606, rather than substantially parallel, as shown in FIGS. 4 and 5. Holding the instrument at this angle can result in ineffective treatment, and possibly even injury to the patient because the working end 604 is not correctly applied to the treatment site. In some embodiments, a slight angle of the terminal shank 602 with respect to the long axis of the tooth 606 is appropriate, however, the angle shown in FIG. 6 demonstrates an incorrect position. Without the colored portion identifying the terminal shank 602, it may be easy to look at FIG. 6 and think the instrument is in the correct position, as part of the functional shank 600 is substantially parallel to the long axis of the tooth 606. This possible misconception helps identify a primary benefit of the disclosed invention—color-coding the terminal shank 602 makes the proper angle and position significantly easier to achieve and maintain throughout treatment.

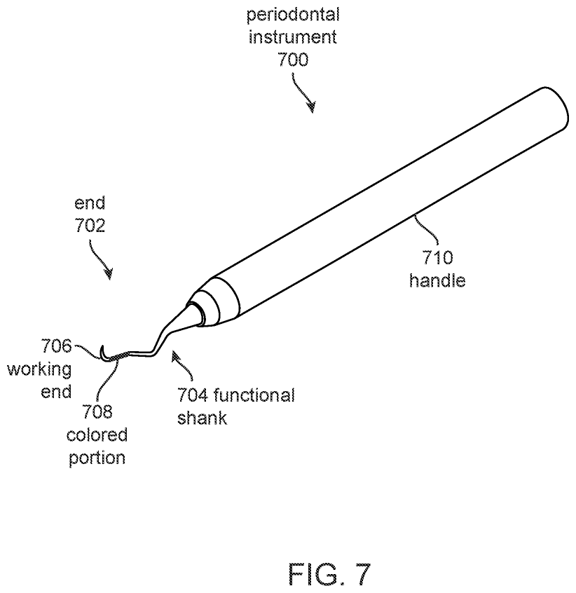

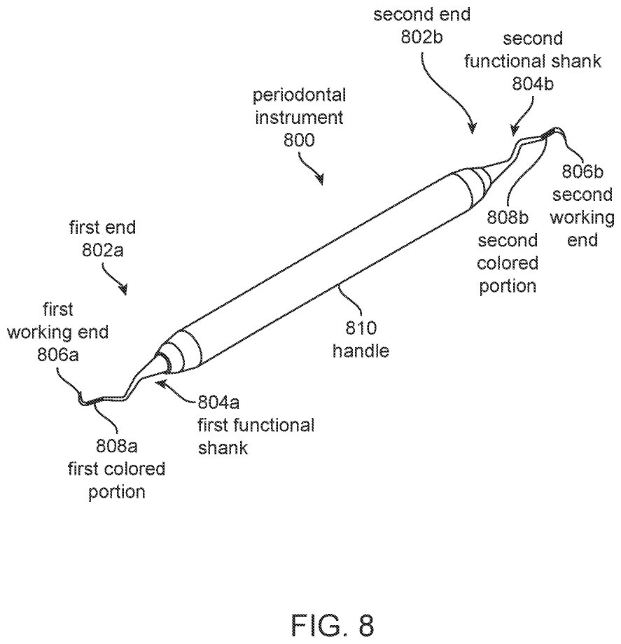

FIG. 7 is similar to FIG. 1, and illustrates a single-ended periodontal instrument 700 with an end 702 comprising a functional shank 704, a working end 706, and a colored portion 708, as well as a handle 710 located proximal to the end 702. Similar to the slight difference between FIGS. 3A and 3B, FIGS. 1 and 7 illustrate substantially the same device, but with differing portions of the functional shanks 104, 704 located adjacent the handle 110, 710. Likewise, FIG. 8 illustrates a double-ended periodontal instrument 800 substantially similar to the periodontal instrument 200 shown in FIG. 2, but with slightly wider portions of the first functional shank 804a and the second functional shank 804b located adjacent the handle 810.

Similar to FIG. 2, the periodontal instrument 800 of FIG. 8 includes a first end 802a comprising a first functional shank 804a, a first working end 806a located distal to the first functional shank 804a, and a first colored portion 808a. In some embodiments, as shown, the periodontal instrument 800 includes a second end 802b comprising a second functional shank 804b including a second colored portion 808b, and a second working end 806b located distal to the second functional shank 804b. Each of the colored portion 708, the first colored portion 808a, and the second colored portion 808b may be configured to identify terminal shanks of the corresponding functional shanks 704, 804a, 804b.

As discussed with reference to FIGS. 1 and 2, the working ends 706, 806a, 806b may comprise one of a rounded end or a pointed end. The working ends 706, 806a, 806b may include zero, one, or two cutting surfaces. Depending on the type of end and number of cutting surfaces, the periodontal instruments 700, 800 may comprise one of an explorer, a scaler, and a curette. The first working end 806a and the second working end 806b may comprise the same type of working end. In some embodiments, the first working end 806a, 806b comprise the same type of working end and are mirror images of one another. The first working end 806a may comprise a different type of working end than the second working end 806b.

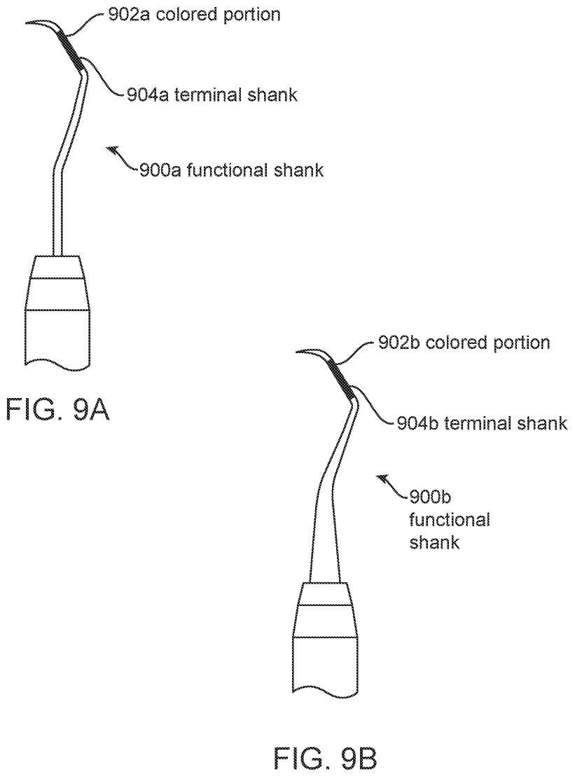

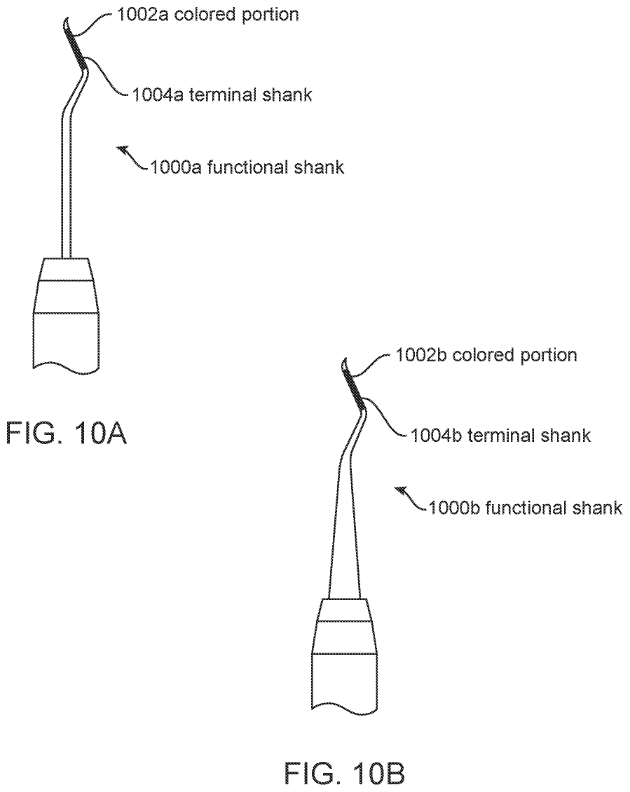

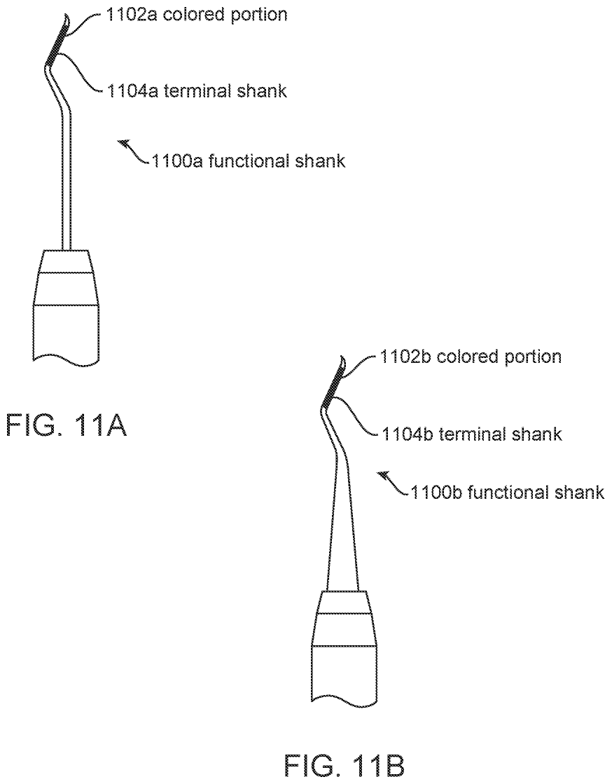

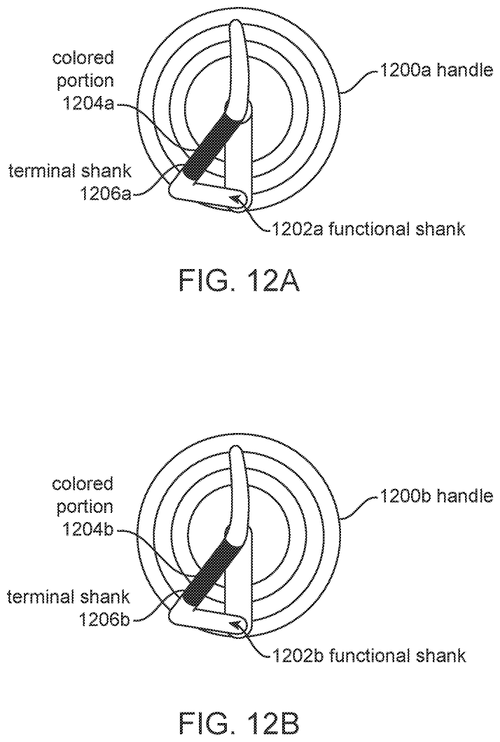

FIGS. 9A, 9B, 10A, 10B, 11A, and 11B are similar to FIGS. 3A and 3B, but illustrate different types of functional shanks. For example, FIGS. 3A, 3B, 9A, and 9B illustrate functional shanks 300a, 300b, 900a, 900b with longer working ends than the functional shanks 1000a, 1000b, 1100a, 1100b of FIGS. 10A, 10B, 11A, and 11B. In some embodiments, as shown in FIGS. 9A and 9B, the functional shanks 900a, 900b include colored portions 902a, 902b defining terminal shanks 904a, 904b. Similarly, FIGS. 10A and 10B include colored portions 1002a, 1002b defining terminal shanks 1004a, 1004b. Likewise, FIGS. 11A and 11B include colored portions 1102a, 1002b defining terminal shanks 1104a, 1004b. FIGS. 12A and 12B are similar to FIGS. 3A, 3B, and 9A-11B, however FIGS. 12A and 12B illustrate front views of an instrument including a handle 1200a, 1200b, a functional shank 1202a, 1202b, and a colored portion 1204a, 1204b. In some embodiments, the colored portions 1204a, 1204b define terminal shanks 1206a, 1206b.

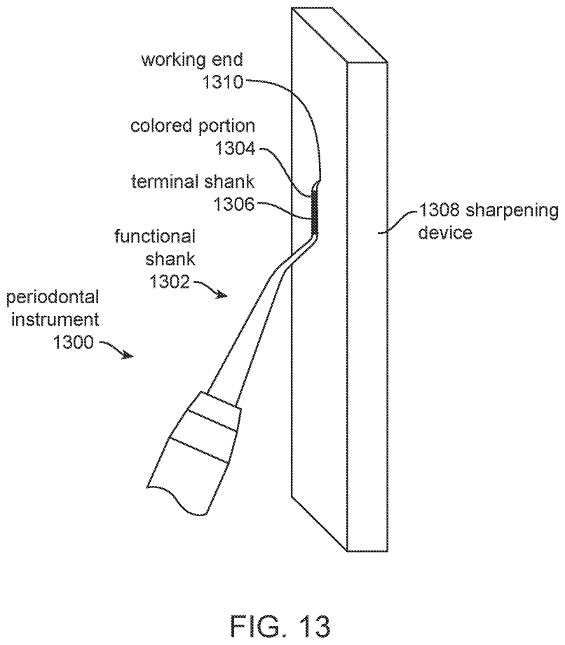

Turning now to FIG. 13, a periodontal instrument 1300 is shown with a sharpening device 1308. As previously mentioned in this disclosure, proper angulation of the terminal shank 1306 of the functional shank 1302 is important not only for use of the periodontal instrument 1300 on a patient, but also during sharpening of the periodontal instrument 1300. If the periodontal instrument 1300 is held such that the terminal shank 1306 is at an incorrect angle, the working end 1310 may not sufficiently contact the sharpening device 1308, resulting in incomplete and/or ineffective sharpening of the working end 1310. Ineffective sharpening of the working end 1310 of an instrument 1300 that is then put back into use can result ineffective treatment, as the working end 1310 may not be sharp enough to sufficiently remove deposit from the patient's teeth. Incorrect angulation during sharpening can also result in damage to the periodontal instrument 1300, and render the instrument 1300 unusable. In some embodiments, the inclusion of a colored portion 1304 to identify the terminal shank 1306 can result in proper angulation and more effective sharpening.

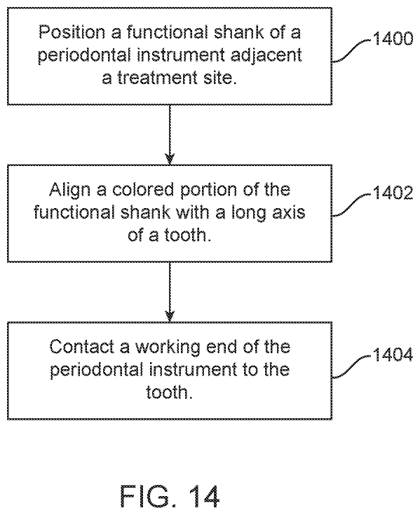

FIG. 14 illustrates a method of using a periodontal instrument. In some embodiments, the method begins with positioning a functional shank of a periodontal instrument adjacent a treatment site, at step 1400. The treatment site may be a tooth, a gum, or another part of a patient's mouth (or a mouth model). In some embodiments, the method continues with aligning a colored portion of the functional shank with a long axis of a tooth, at step 1402. As previously discussed, the colored portion may define a terminal shank of the functional shank. In some embodiments, as shown in FIG. 14, the method includes contacting a working end of the periodontal instrument to the tooth, at step 1404. Contacting the working end to the tooth may initiate treatment, such as the removal of deposit (e.g., plaque) from the tooth by scraping the working end against the tooth's surface. In some embodiments, the working end may be configured to feel for soft spots (i.e., cavities) of a tooth, without any scraping of the tooth. Several different actions may be carried out using the periodontal instrument and the method illustrated in FIG. 14.

In some embodiments, the functional shank mentioned in FIG. 14 comprises a first functional shank, the treatment site comprises a first treatment site, the colored portion comprises a first colored portion, the terminal shank comprises a first terminal shank, and the working end comprises a first working end. Though not shown in FIG. 14, the method may further include positioning a second functional shank of the periodontal instrument adjacent a second treatment site, aligning a second colored portion of the second functional shank with a long axis of a different tooth, and contacting a second working end of the periodontal instrument to the different tooth. In some embodiments, the second functional shank is located opposite the first functional shank and the periodontal instrument comprises a double-ended periodontal instrument, similar to those illustrated in FIGS. 2 and 8. The second colored portion may define a second terminal shank. In some embodiments, the different tooth is located on an opposite side of the mouth from the tooth mentioned in FIG. 14; for example, the first working end is configured to contact a tooth on the left side of a patient's mouth while the second working end is configured to contact a tooth on the right side of the patient's mouth.

The first colored portion (i.e., the first terminal shank) and the second colored portion (i.e., the second terminal shank) may be configured to be aligned substantially parallel to the respective target teeth. In some embodiments, the first terminal shank and the second terminal shank are configured to be aligned at an angle to the respective target teeth. Whether the terminal shanks are aligned substantially parallel or at an angle may depend on the cutting surface(s) of the working ends. For example, in some embodiments, the cutting surface(s) is angled, so the terminal shank can be held parallel. The cutting surface(s) may be level, so the terminal shank needs to be slightly angled toward the tooth in order to achieve the proper angle of the cutting surface(s) with respect to the tooth. In some embodiments, the ideal angle of the cutting surface(s) with respect to the target tooth is between 70 and 80 degrees.

On a double-ended periodontal instrument, such as the periodontal instrument 200 illustrated in FIG. 2 or the periodontal instrument 800 illustrated in FIG. 8, the first colored portion 208a, 808a may define a different color than the second colored portion 208b, 808b. In some embodiments, the first colored portion 208a, 808a defines the same color as the second colored portion 208b, 808b. The first colored portion 208a, 808a and the second colored portion 208b, 808b may define any number of colors, including, but not limited to the following: black, blue, brown, cyan, gold, green, grey, magenta, orange, pink, purple, red, white, yellow, and any respective shades thereof. The possible colors also include any number of patterned designs comprising one or more colors; for example, stripes, dots, and the like. Any of the colored portions illustrated in the Figures may comprise an etching on the functional shanks. In some embodiments, the colored portions comprise a coating on the functional shanks.

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment.

The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” is used to mean “completely” or “nearly completely.” For example, the disclosure includes “In FIG. 4, the terminal shank 402 of the functional shank 400 is shown being held substantially parallel to a long axis of a tooth 406.” In this context, “substantially parallel” means that the terminal shank may be held completely parallel or nearly completely parallel to the long axis of the tooth, and be understood as “substantially parallel,” as the term is used in this disclosure. Any component referred to as “substantially parallel” may be within a few degrees of perfectly parallel and still be considered “substantially” parallel.

The term “adjacent” is used to mean “next to or adjoining something else.” For example, the disclosure includes “In some embodiments, the method begins with positioning a functional shank of a periodontal instrument adjacent a treatment site, at step 1400.” In this context, the functional shank may be positioned next to or adjoining the treatment site, and be considered “adjacent” the treatment site, as the term is used in this disclosure.

The terms “proximal” and “distal” are used to refer to relative directions along a periodontal instrument, with respect to a user holding the handle. For example, in a single-ended periodontal instrument, such as the ones illustrated in FIGS. 1 and 7, the handle is considered the most proximal element, as it is closest to a user of the instrument. The working end is considered the most distal, as it is furthest from the user holding the handle. The functional shank is located distal to the handle, and proximal to the working end. In a double-ended periodontal instrument, such as the ones illustrated in FIGS. 2 and 8, the middle of the handle is considered the most proximal point and each working end is the most distal point. The first functional shank is located distal to the handle and proximal to the first working end, while the second functional shank is located distal to the handle and proximal to the second working end.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

What is claimed is:

1. A periodontal instrument, comprising:
an end including a functional shank and a working end located distal to the functional shank,
wherein the functional shank includes a colored portion; and
a handle configured to extend proximally from the end, the handle sized and configured to be received by a user's hand.

2. The periodontal instrument of claim 1, wherein the end comprises a first end, the functional shank comprises a first functional shank, the working end comprises a first working end, and the colored portion comprises a first colored portion.

3. The periodontal instrument of claim 2,
wherein the first colored portion defines a first terminal shank of the first functional shank, and
wherein the first colored portion is configured to aid the user in identifying the first terminal shank.

4. The periodontal instrument of claim 3, further comprising a second end located opposite the first end, the second end including a second functional shank and a second working end located distal to the second functional shank,
wherein the second functional shank includes a second colored portion.

5. The periodontal instrument of claim 4,
wherein the second colored portion defines a second terminal shank of the second functional shank, and
wherein the second colored portion is configured to aid the user in identifying the second terminal shank.

6. The periodontal instrument of claim 5, wherein the first colored portion defines a different color than the second colored portion.

7. The periodontal instrument of claim 5, wherein the first colored portion defines a same color as the second colored portion.

8. The periodontal instrument of claim 7, wherein the first colored portion and the second colored portion are black.

9. The periodontal instrument of claim 5, wherein the first colored portion comprises a first etching on the first functional shank, and the second colored portion comprises a second etching on the second functional shank.

10. The periodontal instrument of claim 5, wherein the first colored portion comprises a first coating on the first functional shank, and the second colored portion comprises a second coating on the second functional shank.

11. The periodontal instrument of claim 4, wherein the periodontal instrument comprises one of an explorer, a scaler, and a curette.

12. The periodontal instrument of claim 11,
wherein the first working end comprises a first end including a pointed end or a rounded end, and
wherein the second working end comprises a second end including a pointed end or a rounded end.

13. The periodontal instrument of claim 12, wherein the first working end comprises a first end selected from the group consisting of zero cutting surfaces, one cutting surface, and two cutting surfaces, and
wherein the second working end comprises a second end selected from the group consisting of zero cutting surfaces, one cutting surface, and two cutting surfaces.

14. A method of using a periodontal instrument, the method comprising:
positioning a functional shank of the periodontal instrument adjacent a treatment site;
aligning a colored portion of the functional shank with a long axis of a tooth, wherein the colored portion defines a terminal shank of the functional shank; and
contacting a working end of the periodontal instrument to the tooth.

15. The method of claim 14, wherein the functional shank comprises a first functional shank, the treatment site comprises a first treatment site, the colored portion comprises a first colored portion, the terminal shank comprises a first terminal shank, and the working end comprises a first working end, the method further comprising:
positioning a second functional shank of the periodontal instrument adjacent a second treatment site, wherein the second functional shank is located opposite the first functional shank;
aligning a second colored portion of the second functional shank with a long axis of a different tooth, wherein the second colored portion defines a second terminal shank of the second functional shank; and
contacting a second working end of the periodontal instrument to the different tooth.

16. The method of claim 15,
wherein the first colored portion is configured to aid a user of the periodontal instrument in identifying the first terminal shank, and
wherein the second colored portion is configured to aid the user in identifying the second terminal shank.

17. The method of claim 15, wherein when the first working end of the periodontal instrument is in use, the first colored portion is configured to be aligned substantially parallel to the long axis of the tooth.

18. The method of claim 15, wherein when the first working end of the periodontal instrument is in use, the first colored portion is configured to be aligned at an angle to the long axis of the tooth.

19. The method of claim 15, wherein when the second working end of the periodontal instrument is in use, the second colored portion is configured to be aligned substantially parallel to the long axis of the different tooth.

20. The method of claim 15, wherein when the second working end of the periodontal instrument is in use, the second colored portion is configured to be aligned at an angle to the long axis of the different tooth.
